(19) United States
(12) Patent Application Publication
(10) Pub. No.: US 2014/0012634 A1
(43) Pub. Date: Jan. 9, 2014

(54) GEOSPATIAL DATA BASED ASSESSMENT OF FLEET DRIVER BEHAVIOR

(71) Applicants: Richard Frank Pearlman, Carlsbad, CA (US); Sean Micheal Walsh, Redwood City, CA (US); Daris Amon Schantz, Scottsdale, AZ (US); Steven Gertz, Smyrna, GA (US); Alec Michael Hale-Pletka, La Palma, CA (US)

(72) Inventors: Richard Frank Pearlman, Carlsbad, CA (US); Sean Micheal Walsh, Redwood City, CA (US); Daris Amon Schantz, Scottsdale, AZ (US); Steven Gertz, Smyrna, GA (US); Alec Michael Hale-Pletka, La Palma, CA (US)

(21) Appl. No.: 14/022,241

(22) Filed: Sep. 10, 2013

Related U.S. Application Data
(63) Continuation-in-part of application No. 13/941,471, filed on Jul. 13, 2013.
Application No. 13/941,471 is a continuation of application No. 13/421,571, filed on Mar. 15, 2012, now Pat. No. 8,510,200.
Application No. 13/421,571 is a continuation-in-part of application No. 13/310,629, filed on Dec. 2, 2011.
Application No. 13/310,629 is a continuation-in-part of application No. 13/328,070, filed on Dec. 16, 2011.

(51) Int. Cl. G06Q 10/06

(52) U.S. Cl. CPC G06Q 10/06398
USPC 705/7.42

(57) ABSTRACT

Disclosed are methods, devices, and systems to assess the performance of a fleet driver using a geospatial tracking device. In one embodiment, a method is disclosed comprising determining a baseline travel time of a fleet vehicle traveling a fleet route from a departure location to an arrival location; obtaining a dispatch estimated travel time of the fleet vehicle traveling the fleet route from a dispatcher; obtaining a driver estimated travel time of the fleet vehicle; determining an actual travel time of the fleet vehicle traveling the fleet route through a geospatial tracking device; and generating a driver performance score of the driver of the fleet vehicle for a duration of the fleet route based on the baseline travel time, the dispatch estimated travel time, the driver estimated travel time, and/or the actual travel time.

### CLAIM OF PRIORITY

This non-provisional patent application is a Continuation-In-Part (CIP) application of, claims priority to, and incorporates by reference in its entirety United States (U.S.) non-provisional patent application Ser. No. 13/941,471 filed on Jul. 13, 2013, which, in turn, claims priority to: U.S. non-provisional patent application Ser. No. 13/421,571 filed on Mar. 15, 2012, now issued as U.S. Pat. No. 8,510,200, U.S. non-provisional application Ser. No. 13/310,629 filed on Dec. 2, 2011, and U.S. non-provisional application Ser. No. 13/328,070 filed on Dec. 16, 2011.

### FIELD OF TECHNOLOGY

This disclosure relates generally to the field of geospatial tracking, and, more specifically, to methods, devices, and systems for geospatial data based assessment of fleet driver behavior.

### BACKGROUND

Fleet driver safety and efficiency are of paramount concern to any organization running or managing a fleet of commercial vehicles involved in long-distance travel. Such commercial vehicle fleets are typically comprised of trucks and other heavy duty vehicles that usually transport high value goods over vast distances. Therefore, organizations interested in assessing the efficiency and/or performance of their fleet drivers may be interested in assessing the driving behavior of the fleet driver. In addition, the organization may be interested in assessing the driving behavior of the fleet driver in relation to the driving behavior of other fleet drivers in the organization.

While methods abound for tracking the positions of such fleet vehicles (e.g., GPS, RTLS, RFID, etc.), there is a need for solutions that make the most effective use of such tracking data to gauge the safety and efficiency of fleet vehicle drivers.

### SUMMARY

In one aspect of the disclosure, a method is disclosed comprising the operations of determining a baseline travel time of a fleet vehicle traveling a fleet route from a departure location to an arrival location through a processor of a server device. The method also includes obtaining a dispatch estimated travel time of the fleet vehicle traveling the fleet route from a dispatcher of the fleet vehicle through the processor of the server device. In addition, the method includes obtaining a driver estimated travel time of the fleet vehicle traveling the fleet route from the driver of the fleet vehicle through the processor of the server device. Moreover, the method includes determining an actual travel time of the fleet vehicle traveling the fleet route through a geospatial tracking device coupled to the fleet vehicle through the processor of the server device. Furthermore, the method includes generating a driver performance score of the driver of the fleet vehicle for a duration of the fleet route based on the baseline travel time, the dispatch estimated travel time, the driver estimated travel time, and/or the actual travel time.

In another aspect of the disclosure, a fleet vehicle driver assessment system is disclosed comprising a geospatial tracking device coupled to a fleet vehicle communicatively coupled to one or more server devices. In this aspect, the one or more server devices are configured to calculate a baseline travel time of the fleet vehicle traveling a fleet route from a departure location to an arrival location by one or more processors of the one or more server devices. In addition, the one or more server devices are configured to obtain a dispatch estimated travel time of the fleet vehicle traveling the fleet route from a dispatcher of the fleet vehicle by one or more processors of the server devices. Moreover, the one or more server devices are configured to obtain a driver estimated travel time of the fleet vehicle traveling the fleet route through a driver mobile device communicatively coupled to the one or more server devices by one or more processors of the one or more server devices. Furthermore, the one or more server devices are configured to determine an actual travel time of the fleet vehicle traveling the fleet route through the geospatial tracking device coupled to the fleet vehicle by one or more processors of the one or more server devices. Additionally, the one or more server devices are configured to generate a driver performance score of the driver of the fleet vehicle for a duration of the fleet route based on the baseline travel time, the dispatch estimated travel time, the driver estimated travel time, and/or the actual travel time.

In yet another aspect, a server device is disclosed comprising a baseline travel module configured to determine a baseline travel time of a fleet vehicle traveling a fleet route from a departure location to an arrival location. The server device also includes a dispatcher module configured to obtain a dispatch estimated travel time of the fleet vehicle traveling the fleet route from a dispatcher of the fleet vehicle. In addition, the server device includes a driver tracking module configured to obtain a driver estimated travel time of the fleet vehicle traveling the fleet route from a driver of the fleet vehicle. Moreover, the server device includes a vehicle tracking module configured to determine an actual travel time of the fleet vehicle traveling the fleet route through a geospatial tracking device coupled to the fleet vehicle and in communicative contact with the server device. Furthermore, the server device includes a driver performance module configured to generate a driver performance score of the driver of the fleet vehicle for a duration of the fleet route based on the baseline travel time, the dispatch estimated travel time, the driver estimated travel time, and/or the actual travel time.

The methods, devices, and systems disclosed herein may be implemented in any means for achieving the various aspects, and may be executed in the form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements.

FIG. 1 illustrates an exemplary fleet vehicle driver assessment system, according to one or more embodiments.

FIG. 2 illustrates an exemplary schematic diagram of modules of the fleet vehicle driver assessment system, according to one or more embodiments.

FIG. 3 illustrates an exemplary computation table showing the determination of a driver performance score, according to one or more embodiments.

FIG. 4 is an exemplary display interface of a fleet vehicle display, according to one or more embodiments.

FIG. 5 is a process flow illustrating an exemplary method disclosed herein, according to one or more embodiments.

FIG. 6 is another process flow illustrating another exemplary method disclosed herein, according to one or more embodiments.

FIG. 7 is a schematic diagram of exemplary data processing devices that can be used to implement the methods and systems disclosed herein, according to one or more embodiments.

Other features of the present embodiments will be apparent from the accompanying drawings and from the detailed description that follows.

### DETAILED DESCRIPTION

Disclosed are methods, devices, and systems to assess the performance of a fleet driver using a geospatial tracking device. Although the present embodiments have been described with reference to specific example embodiments, it will be evident that various modifications and changes may be made to these embodiments without departing from the broader spirit and scope of the various embodiments. It should be understood by one of ordinary skill in the art that the terms “application(s),” “program(s),” “software,” “software code,” “sub-program(s),” and “block(s)” are industry terms that refer to computing instructions stored in memory and executable by one or more processors.

In addition, the term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a micro-electromechanical system (MEMS), passive devices, or a combination thereof. Moreover, the components shown in the figures, their connections, couples, and relationships, and their functions, are meant to be exemplary only, and are not meant to limit the embodiments described herein.

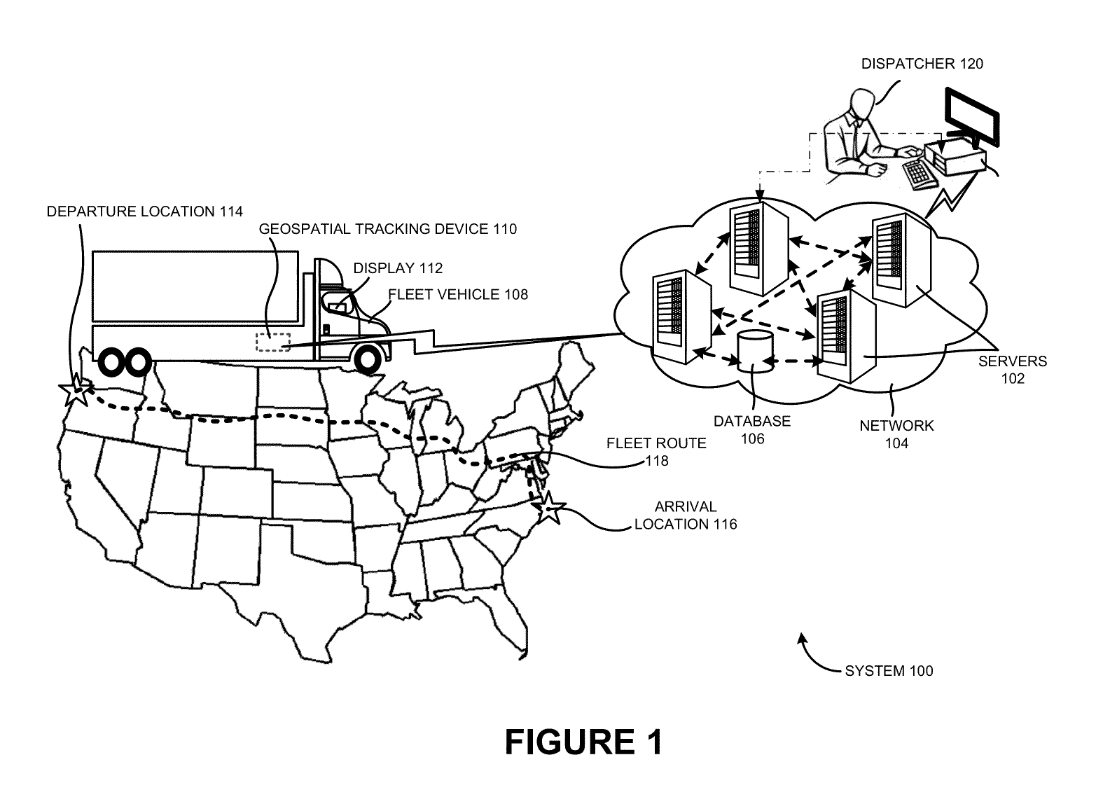

Reference is now made to FIG. 1, which shows an exemplary fleet vehicle driver assessment system 100, according to one or more embodiments. As shown in FIG. 1, the fleet vehicle driver assessment system 100 may comprise one or more servers 102 communicatively coupled to a geospatial tracking device 110 of a fleet vehicle 108. In addition, the one or more servers 102 may be communicatively coupled to dispatcher device 122, a driver device 124, and a database 106 through a network 104. In one embodiment, the geospatial tracking device 110 may be powered by the power source of the fleet vehicle 108 and may be directly coupled to the electrical circuitry of the fleet vehicle 108. In another embodiment, the geospatial tracking device 110 may be powered by an external power source and may be communicatively coupled to the electrical circuitry of the fleet vehicle 108. In one embodiment, the fleet vehicle driver may be a truck driver or a long-haul truck driver and the fleet vehicle 108 may be a fleet truck or delivery truck.

In one embodiment, the geospatial tracking device 110 may communicate geospatial data based on a worldwide navigational and surveying system dependent on the reception of signals from one or more orbiting positioning satellites (e.g., Global Positioning System (GPS) satellites). In another embodiment, the geospatial tracking device 110 may be a Real Time Locator System (RTLS), which uses radio frequency identification (RFID) technology to transmit the location of RFID tagged objects to a central communication hub. In yet another embodiment, the geospatial tracking device 110 may be a wireless device configured to receive communication signals through one or more cellular networks. In this case, the network may comprise signals sent through a Global System for Mobile Communication (“GSM”) protocol, a Code Division Multiple Access (“CDMA”) protocol, a Time Division Multiple Access (“TDMA”) protocol, a Personal Digital Cellular (“PDC”) protocol, a Wideband Code Division Multiple Access (“WCDMA”) protocol, a CDMA 2000 protocol, and/or a General Packet Radio Services (“GPRS”) protocol. In one or more embodiments, the geospatial tracking device 110 may be coupled to the fleet vehicle 108 by an Original Equipment Manufacturer (OEM). In one or more embodiments, the one or more cellular networks may be the network 104.

In one embodiment, the one or more servers 102 may comprise of servers in a multiple-node cloud computing environment. In this and other embodiments, the one or more servers 102 may be communicatively coupled to a dispatcher device 122 and a driver device 124 through the network 104. In another embodiment, the one or more servers 102 may be stand-alone servers communicatively coupled to a dispatcher device 122 and a driver device 124 through the network 104.

In one or more embodiments the network 104 may be a wireless network and the dispatcher device 122 and the driver device 124 may be communicatively coupled to the wireless network through a wireless connection. In these and other embodiments, the wireless connection may comprise communication paths involving satellite signals, Bluetooth® signals, infrared signals, wireless fidelity signals, and any long-range or short-range radio frequency signals known to one of ordinary skill in the art. In addition, the network 104 may comprise a local area network (LAN), a wide area network (WAN), or any combination thereof. In one or more embodiments, the network 104 may be a cellular network. In these embodiments, the network may facilitate the transmission of signals sent and received through a Global System for Mobile Communications (“GSM”) protocol, a Short Messaging Service (“SMS”) protocol, an Enhanced Messaging System (“EMS”) protocol, a Multimedia Messaging Service (“MMS”) protocol, a Code Division Multiple Access (“CDMA”) protocol, a Time Division Multiple Access (“TDMA”) protocol, a Personal Digital Cellular (“PDC”) protocol, a Wideband Code Division Multiple Access (“WCDMA”) protocol, a Wideband Code Division Multiple Access (“WCDMA”) protocol, a CDMA 2000 protocol, and/or a General Packet Radio Service (“GPRS”) protocol.

As will be discussed in the following sections, the one or more servers 102 may receive geospatial coordinate data from the geospatial tracking device 110 as the fleet vehicle 108 travels from a departure location 114 to an arrival location 116. Such a travel route may be referred to as a fleet route 118 in the following sections. One or more processors of the one or more servers 102 may store the geospatial coordinate data in one or more databases (for example, the database 106) communicatively coupled to the one or more servers through the network 104. In addition, the one or more processors of the one or more servers 102 may store data received from the dispatcher device 122 and the driver device 124 in the one or more databases (for example, the database 106) through the network 104.

Although the example embodiment shown in FIG. 1 illustrates the one or more servers 102 tracking the progress of a single fleet vehicle 108 and communicatively coupled to a single dispatcher device 122 and a single driver device 124, it should be understood by one of ordinary skill in the art that the one or more servers 102 can track the progress of multiple fleet vehicles simultaneously and can be communicatively coupled to multiple dispatcher devices and multiple driver devices at any one time.

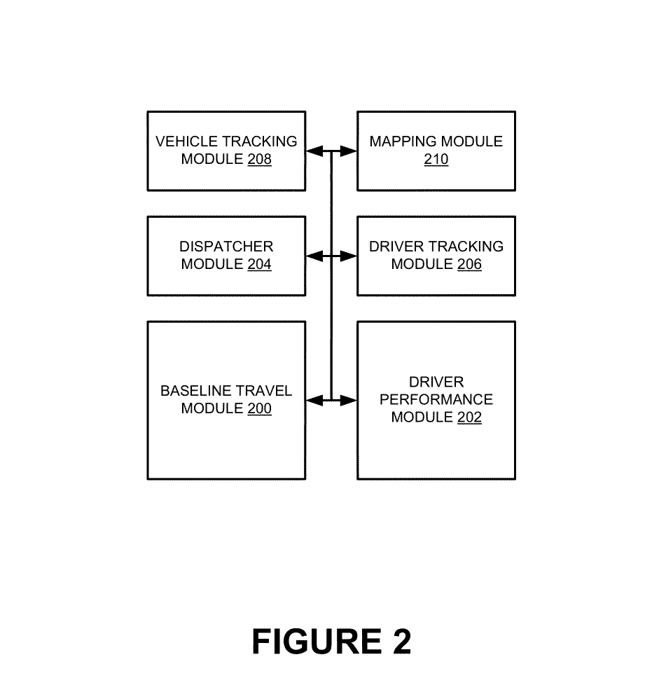

Reference is now made to FIG. 2, which is an exemplary schematic diagram of modules of the fleet vehicle driver assessment system 100, according to one or more embodiments. As shown in FIG. 2, the fleet vehicle driver assessment system 100 may comprise a baseline travel module 200, a driver performance module 202, a dispatcher module 204, a driver tracking module 206, a vehicle tracking module 208, and a mapping module 210. In one or more embodiments, the baseline travel module 200, the driver performance module 202, the dispatcher module 204, the driver tracking module 206, the vehicle tracking module 208, and the mapping module 210 may be communicatively coupled to one another through high-speed buses (in cases where the modules are hardware modules or application specific integrated circuits (ASICs)) or routines and/or subroutines (in cases where the modules are software or firmware modules). In the case where the aforementioned modules are hardware modules or ASICs, the modules may be embedded in one server of the one or more servers 102 or may be embedded (separately or as a combination of modules) in multiple servers of the one or more 102. In the case where the aforementioned modules are software or firmware modules, the aforementioned modules may be stored in a memory device of one server in the one or more servers 102 or may be stored in multiple memory devices (separately or as a combination of modules) of multiple servers of the one or more servers 102.

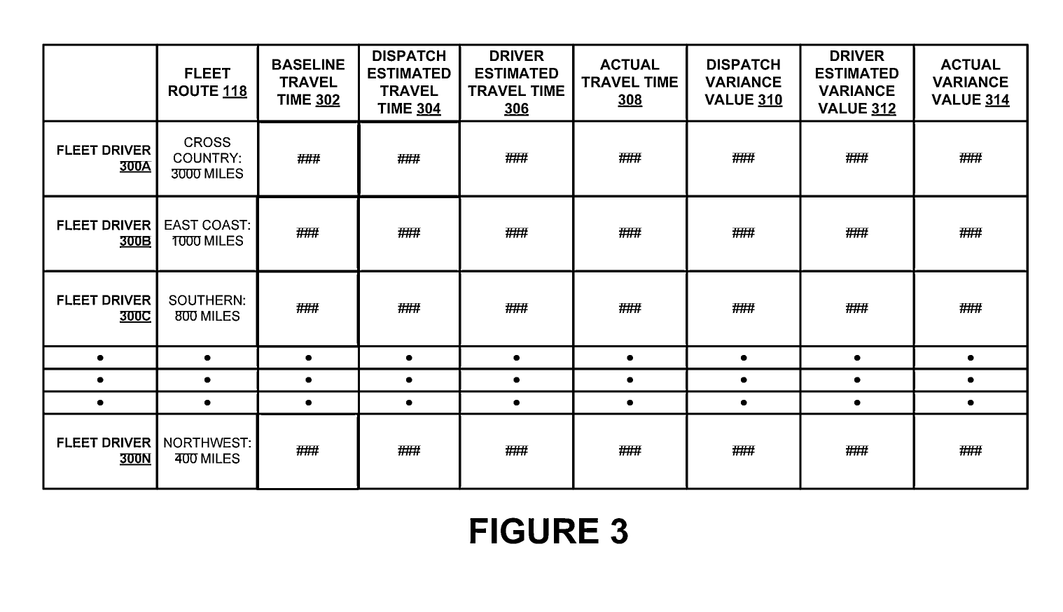

In one or more embodiments, the baseline travel module 200 may be configured to determine a baseline travel time 302 (see FIG. 3) of the fleet vehicle 108 traveling the fleet route 118 from the departure location 114 to the arrival location 116. In these embodiments, the baseline travel module 200 may apply a baseline travel algorithm to calculate the baseline travel time 302. In one embodiment, the baseline travel algorithm comprises segmenting a total distance of the fleet route 118 into a plurality of sub-distances based on a posted speed limit of each of the plurality of sub-distances. The baseline travel algorithm also may comprise dividing the plurality of sub-distances by their respective posted speed limits to obtain a plurality of resultant sub-distance travel times. Finally, the baseline travel algorithm may comprise summing the plurality of resultant sub-distance travel times to obtain the baseline travel time 302.

In addition, the dispatcher module 204 may be configured to obtain a dispatch estimated travel time 304 (see FIG. 3) from the dispatcher 120 through the dispatch device 122. In these and other embodiments, the dispatcher module 204 may obtain the dispatch estimated travel time 304 when the dispatcher 120 manually enters the dispatch estimated travel time 304 into an input field displayed on the dispatch device 122. In one embodiment, the dispatcher 120 may enter the dispatch estimated travel time 304 at the beginning of the fleet vehicle 108's fleet route 118 before the fleet vehicle 108 has departed the departure location 114. In this embodiment, the dispatcher 120 may take into account historical data concerning the actual travel times of past fleet routes traveled by the driver of the fleet vehicle 108 and the driver performance score of the driver for such past fleet routes. In another embodiment, the dispatcher 120 may revise the dispatch estimated travel time 304 continuously throughout the fleet vehicle 108's travel on the fleet route 118 and may update the dispatch estimated travel time 304 at predetermined and/or ad hoc time intervals. The dispatcher module 204 may store the dispatch estimated travel time 304 and all updates to the dispatch estimated travel time 304 in the database 106 and may apply one or more weighted-average algorithms to arrive at the dispatch estimated travel time 304 if multiple dispatch estimated travel times are stored throughout the duration of the fleet vehicle 108's travel over the fleet route 118. In all such embodiments, the dispatch estimated travel time 304 may factor in a plurality of unplanned stop time periods (e.g., bathroom breaks, traffic jams during rush hour, etc.) and a plurality of planned stop time periods (e.g., driver rest times, driver meal times, etc.) into the estimation of the dispatch estimated travel time 304.

In one or more embodiments, the driver tracking module 206 may be configured to obtain a driver estimated travel time 306 (see FIG. 3) of the fleet vehicle 108 traveling the fleet route 118. In these and other embodiments, the driver tracking module 206 may obtain the driver estimated travel time 306 when the driver of the fleet vehicle 108 manually enters the driver estimated travel time 306 into an input field displayed on the dispatch device 122. In one embodiment, the driver of the fleet vehicle 108 may enter the driver estimated travel time 306 at the beginning of the fleet vehicle 108's fleet route 118 before the fleet vehicle 108 has departed the departure location 114. In this embodiment, the driver may take into account historical data concerning his own past actual travel times of fleet routes traveled by the fleet vehicle 108 over the same or similar fleet routes to arrive at the driver estimated travel time 306. In addition, the driver may take into account his own past driver performance scores when arriving at the driver estimated travel time 306. In another embodiment, the driver may revise the driver estimated travel time 306 continuously throughout the fleet vehicle 108's travel on the fleet route 118 and may update the driver estimated travel time 306 at predetermined and/or ad hoc time intervals. The driver tracking module 206 may store the driver estimated travel time 306 and all updates to the driver estimated travel time 306 in the database 106 and may apply one or more weighted-average algorithms to arrive at the driver estimated travel time 306 if multiple driver estimated travel times are stored throughout the duration of the fleet vehicle 108's travel over the fleet route 118. In all such embodiments, the driver estimated travel time 306 may factor in a plurality of unplanned stop time periods (e.g., bathroom breaks, traffic jams during rush hour, etc.) and a plurality of planned stop time periods (e.g., driver rest times, driver meal times, etc.) into the estimation of the driver estimated travel time 306.

In one or more embodiments, the vehicle tracking module 208 may be configured to determine an actual travel time 308 (see FIG. 3) of the fleet vehicle 108 traveling the fleet route 118 through the geospatial tracking device 110 coupled to the fleet vehicle 108. In one embodiment, the geospatial tracking device 110 may transmit telemetry data associated with the fleet vehicle 108 to the one or more server 102 as the fleet vehicle 108 is in motion over the fleet route 118. In another embodiment, the geospatial tracking device 110 may transmit the fleet vehicle 108's geospatial coordinates to the one or more servers 102 at pre-determined time intervals throughout the fleet vehicle 108's travel over the fleet route 118. In one embodiment, the actual travel time 308 may be the total amount of time that the fleet vehicle 108 requires to reach the arrival location 116 once the fleet vehicle 108 has departed the departure location 114.

In one or more embodiments, the driver performance module 202 may be configured to calculate or generate a driver performance score of the driver of the fleet vehicle 108 for a duration of the fleet route 118 based on a driver performance algorithm.

In one embodiment, the driver performance algorithm comprises determining a dispatch variance value 310 (see FIG. 3) by obtaining a percentage variance between the dispatch estimated travel time 304 and the baseline travel time 302. Moreover, the driver performance algorithm comprises determining a driver estimated variance value (see FIG. 3) by obtaining a percentage variance between the driver estimated travel time 306 and the baseline travel time 302. In addition, the driver performance algorithm comprises determining an actual variance value 314 (see FIG. 3) by obtaining a percentage variance between the actual travel time 308 and the baseline travel time 302. Furthermore, the driver performance algorithm comprises aggregating the dispatch variance value, the driver estimated variance value, and the actual variance value to obtain a driver performance score of the driver of the fleet vehicle for the duration of the fleet route 118 traveled. In one or more embodiments, the variance values may be calculated by obtaining a percentage weighted value between the dispatch estimated travel time 304, the driver estimated travel time 306, and the actual travel time 308 against the baseline travel time 302.

Reference is now made to FIG. 3, which is an exemplary computation table showing the determination of a driver performance score, according to one or more embodiments. As shown in FIG. 3, the fleet route 118, the baseline travel time 302, the dispatch estimated travel time 304, the driver estimated travel time 306, the actual travel time 308, the dispatch variance value 310, the driver estimated variance value 312, and the actual variance value 314 for multiple fleet vehicle drivers (for example, fleet drivers 300A-300N) may be stored in the exemplary computation table shown. In one embodiment, the computation table may be stored in the database 106. In another embodiment, the computation table may be stored in multiple databases communicatively coupled to the one or more servers 102.

In one example determination of a driver performance score, fleet driver 300A may be driving a cross country fleet route of 3000 miles. In this example scenario, the baseline travel module 200 may use the one or more processors of the one or more servers 102 to segment the total fleet route distance into a plurality of sub-distances based on the posted speed limits of such sub-distances throughout the fleet route. Additionally, a plurality of resultant sub-distance travel times may be calculated ranging from 0.5 hours to 4 hours. In this example scenario, summing the plurality of resultant sub-distance travel times may yield a baseline travel time 302 of 50 hours.

Moreover, the dispatcher module 204 may obtain a dispatch estimated travel time 304 of 80 hours from the dispatcher 120 through the dispatcher device 122 based on the past actual driving times and past driver performance scores of the driver. In addition, the driver tracking module may obtain a driver estimated travel time from fleet driver 300A through the driver device 124. Based on the driver's past driving times, the driver may input a driver estimated travel time of 90 hours. Moreover, during the fleet vehicle 108's progression over the fleet route 118, the vehicle tracking module 208 may determine a series of actual travel times for the driver based on geospatial data received from the geospatial tracking device 110 coupled to the fleet vehicle 108. Finally, the driver performance module 202 may use the one or more processors of the one or more servers 102 to generate one or more driver performance scores rating the efficiency and safety of the driver for one or more durations of the fleet route 118. In one example embodiment, the driver performance module 202 may generate the one or more driver performance scores by applying the driver performance algorithm using the driver's dispatch variance values, driver estimated variance values, and actual variance values. In this example scenario, the variance values may be calculated using percentage differences or through a percentage weighted-average analysis where a percentage weighted average is calculated between the estimated travel times and the baseline travel times.

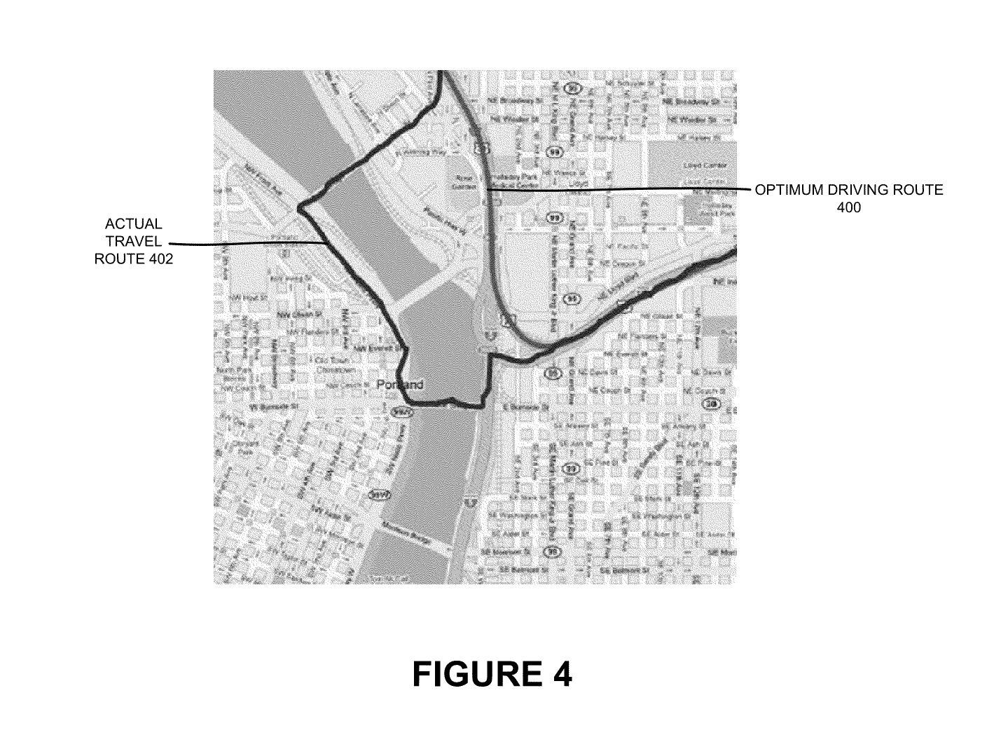

Reference is now made to FIG. 4, which is an exemplary display interface of a fleet vehicle display, according to one or more embodiments. In one embodiment, the one or more servers 102 may generate an optimum driving route 400 for the remainder of the fleet vehicle 108's fleet route 118 when the actual travel time for a duration of the fleet route 118 is above the dispatch estimated travel time 304 for that particular duration of the fleet route 118 by a variance threshold. In another embodiment, the one or more servers 102 may generate the optimum driving route 400 for the remainder of the fleet vehicle 108's fleet route 118 when the actual travel time for the duration of the fleet route 118 traveled is above the driver estimated travel time 306 by a variance threshold time. In one embodiment, the variance threshold may be determined by the dispatcher 120 and the one or more servers 102 may receive the variance threshold from the dispatcher device 122. In these and other embodiments, the variance threshold may be stored in the database 106 and may be retrieved by the one or more servers 102. In one embodiment, the optimum driving route 400 may be determined through a mapping algorithm by the mapping module 210 of the one or more servers 102. In one or more embodiments, the mapping algorithm may take into account the baseline travel time 302, real-time and historical traffic conditions, real-time and historical road conditions, and real-time and historical weather conditions. In one embodiment, one or more application programming interfaces (APIs) may translate the optimum driving route 400 determined by the one or more servers 102 into a form compliant with a third-party mapping service (e.g., Google Maps®, Mapquest®, Apple Maps®, etc.).

In addition, as shown in FIG. 4, the one or more servers 102 may transmit the optimum driving route 400 to the display 112 of the driver device 124 communicatively coupled to the one or more servers 102. Also as shown in FIG. 4, the one or more servers 102 may also transmit an actual travel route 402 traveled by the fleet vehicle 108 to the display 112 of the driver device 124. In one or more embodiments, the actual travel route 402 may be determined based on tracking data received from the geospatial tracking device 110 communicatively coupled or in communicative contact with the one or more servers 102. In these and other embodiments, the graphical user interface displayed on the display 112 may include any form of digital information including text, graphics, photographs, animation, audio, and/or video.

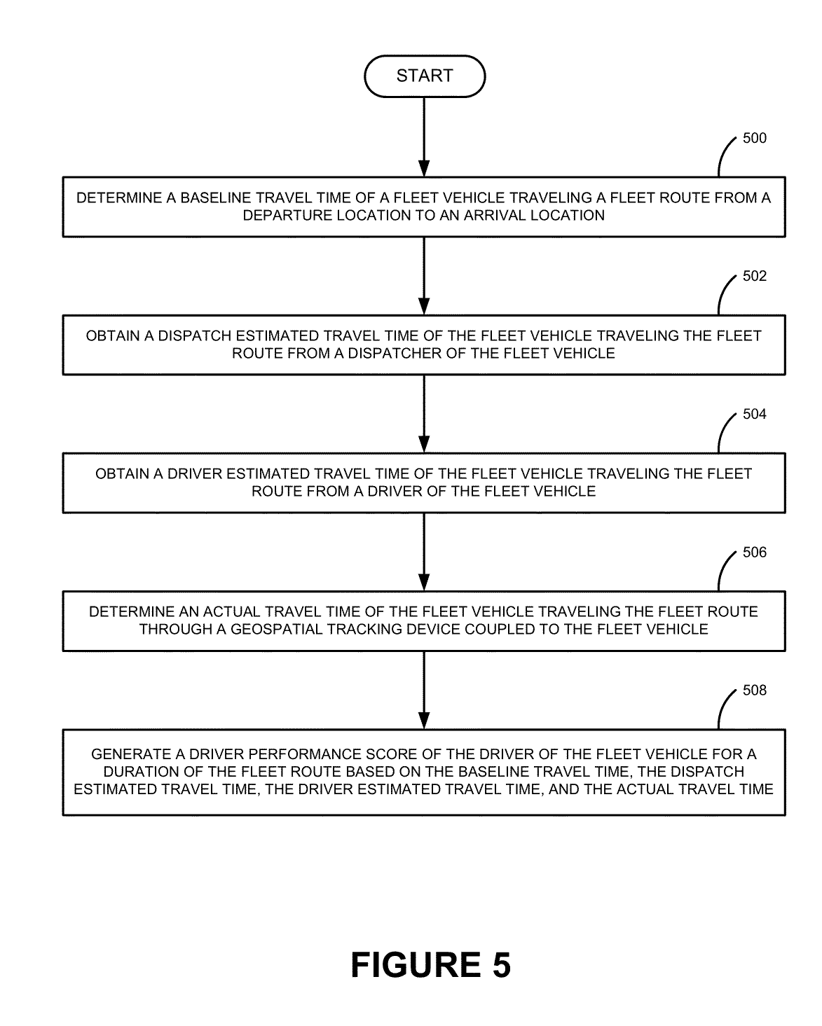

Reference is now made to FIG. 5, which is a process flow illustrating an exemplary method disclosed herein, according to one or more embodiments. Specifically, operation 500 may involve determining the baseline travel time 302 of the fleet vehicle 108 traveling the fleet route 118 from the departure location 114 to the arrival location 116 through the one or more processors of the one or more servers 102. Operation 502 may involve obtaining the dispatch estimated travel time 304 of the fleet vehicle 108 traveling the fleet route 118 from the dispatcher 120 of the fleet vehicle 108 through the one or more processors of the one or more servers 102. In addition, operation 504 may involve obtaining the driver estimated travel time 306 of the fleet vehicle 108 traveling the fleet route 118 from a driver of the fleet vehicle 108. Moreover, operation 506 may involve determining the actual travel time 308 of the fleet vehicle 108 traveling the fleet route 118 through the geospatial tracking device 110 coupled to the fleet vehicle 108. Furthermore, operation 508 may involve generating a driver performance score of the driver of the fleet vehicle 108 for a duration of the fleet route 118 based on the baseline travel time 302, the dispatch estimated travel time 304, the driver estimated travel time 306, and the actual travel time 308.

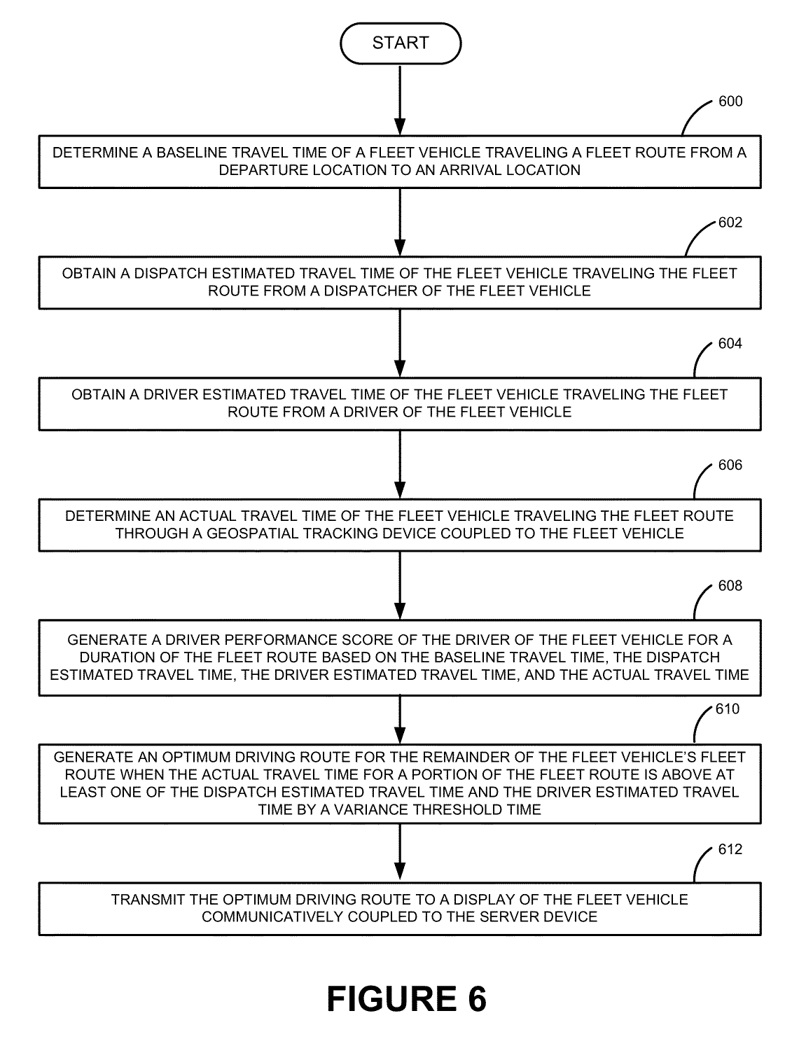

Reference is now made to FIG. 6, which is another process flow illustrating another exemplary method disclosed herein, according to one or more embodiments. Specifically, operation 600 may involve determining the baseline travel time 302 of the fleet vehicle 108 traveling the fleet route 118 from the departure location 114 to the arrival location 116 through the one or more processors of the one or more servers 102. Operation 602 may involve obtaining the dispatch estimated travel time 304 of the fleet vehicle 108 traveling the fleet route 118 from the dispatcher 120 of the fleet vehicle 108 through the one or more processors of the one or more servers 102. In addition, operation 604 may involve obtaining the driver estimated travel time 306 of the fleet vehicle 108 traveling the fleet route 118 from a driver of the fleet vehicle 108. Moreover, operation 606 may involve determining the actual travel time 308 of the fleet vehicle 108 traveling the fleet route 118 through the geospatial tracking device 110 coupled to the fleet vehicle 108. Furthermore, operation 608 may involve generating a driver performance score of the driver of the fleet vehicle 108 for a duration of the fleet route 118 based on the baseline travel time 302, the dispatch estimated travel time 304, the driver estimated travel time 306, and the actual travel time 308. Additionally, operation 610 may involve generating the optimum driving route 400 for the remainder of the fleet vehicle 108's fleet route 118 when the actual travel time for the duration of the fleet route 118 traveled is above the dispatch estimated travel time 304 and/or the driver estimated travel time 306 by a variance threshold time. In addition, operation 612 may involve transmitting the optimum driving route 400 to the display 112 of the driver device 124 communicatively coupled to the one or more servers 102.

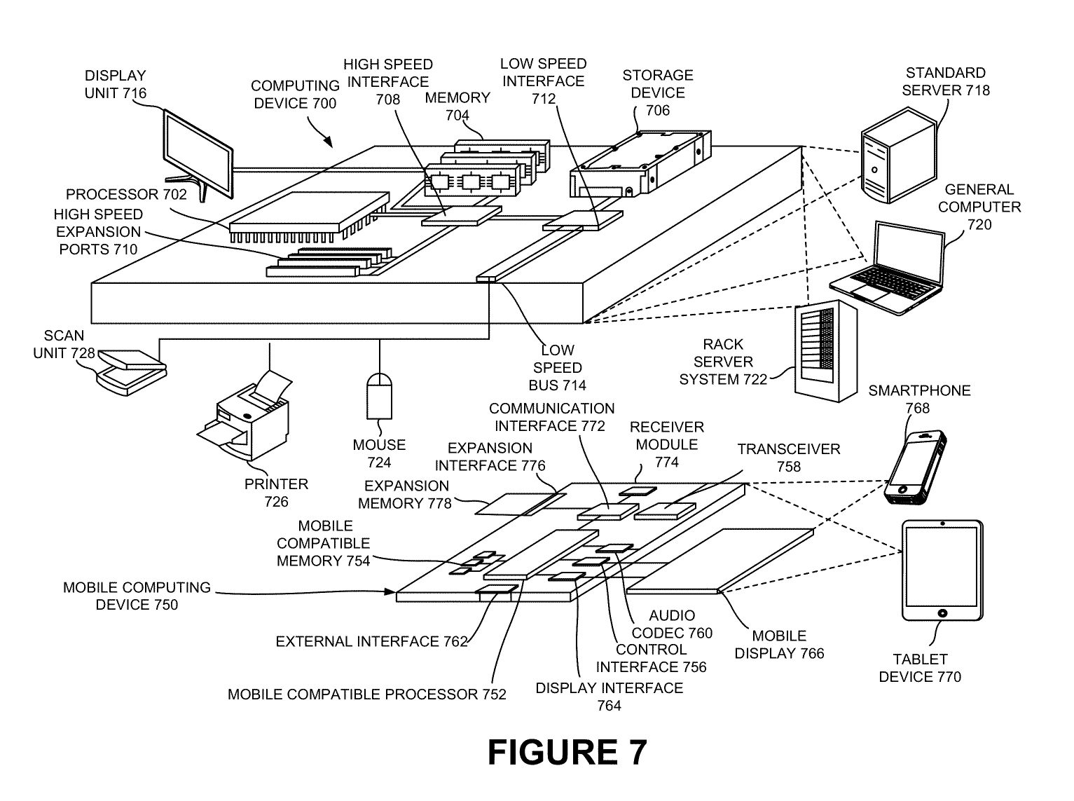

FIG. 7 is a schematic of a computing device 700 and a mobile device 750 that can be used to perform and/or implement any of the embodiments disclosed herein. In one or more embodiments, any of the one or more servers 102 may be the computing device 700. In addition, the driver device 124 and the dispatcher device 122 may be either the computing device 700 or the mobile device 750.

The computing device 700 may represent various forms of digital computers, such as laptops, desktops, workstations, personal digital assistants, servers, blade servers, mainframes, and/or other appropriate computers. The mobile device 750 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

The computing device 700 may include a processor 702, a memory 704, a storage device 706, a high speed interface 708 coupled to the memory 704 and a plurality of high speed expansion ports 710, and a low speed interface 712 coupled to a low speed bus 714 and a storage device 706. In one embodiment, each of the components heretofore may be inter-coupled using various buses, and may be mounted on a common motherboard and/or in other manners as appropriate. The processor 702 may process instructions for execution in the computing device 700, including instructions stored in the memory 704 and/or on the storage device 706 to display a graphical information for a GUI on an external input/output device, such as a display unit 716 coupled to the high speed interface 708. In other embodiments, multiple processors and/or multiple buses may be used, as appropriate, along with multiple memories and/or types of memory. Also, a plurality of computing devices 700 may be coupled with, with each device providing portions of the necessary operations (e.g., as a server bank, a group of blade servers, and/or a multi-processor system).

The memory 704 may be coupled to the computing device 700. In one embodiment, the memory 704 may be a volatile memory. In another embodiment, the memory 704 may be a non-volatile memory. The memory 704 may also be another form of computer-readable medium, such as a magnetic and/or an optical disk. The storage device 706 may be capable of providing mass storage for the computing device 700. In one embodiment, the storage device 706 may be comprised of at least one of a floppy disk device, a hard disk device, an optical disk device, a tape device, a flash memory and/or other similar solid state memory device. In another embodiment, the storage device 706 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in at least one of the memory 704, the storage device 706, a memory coupled to the processor 702, and/or a propagated signal.

The high speed interface 708 may manage bandwidth-intensive operations for the computing device 700, while the low speed interface 712 may manage lower bandwidth-intensive operations. Such allocation of functions is exemplary only. In one embodiment, the high-speed interface 708 may be coupled to at least one of the memory 704, the display unit 716 (e.g., through a graphics processor and/or an accelerator), and to the plurality of high speed expansion ports 710, which may accept various expansion cards. In the embodiment, the low speed interface 712 may be coupled to at least one of the storage device 706 and the low-speed bus 714. The low speed bus 714 may be comprised of a wired and/or wireless communication port (e.g., a Universal Serial Bus (“USB”), a Bluetooth® port, an Ethernet port, and/or a wireless Ethernet port). The low speed bus 714 may also be coupled to at least one of scan unit 728, a printer 726, a keyboard, a mouse 724, and a networking device (e.g., a switch and/or a router) through a network adapter.

The computing device 700 may be implemented in a number of different forms, as shown in the figure. In one embodiment, the computing device 700 may be implemented as a standard server 718 and/or a group of such servers. In another embodiment, the computing device 700 may be implemented as part of a rack server system 722. In yet another embodiment, the computing device 700 may be implemented as a general computer 720 such as a laptop or desktop computer. Alternatively, a component from the computing device 700 may be combined with another component in a mobile device 750. In one or more embodiments, an entire system may be made up of a plurality of computing devices 700 and/or a plurality of computing devices 700 coupled to a plurality of mobile devices 750.

In one embodiment, the mobile device 750 may comprise at least one of a mobile compatible processor 752, a mobile compatible memory 754, and an input/output device such as a mobile display 766, a communication interface 772, and a transceiver 758, among other components. The mobile device 750 may also be provided with a storage device, such as a microdrive or other device, to provide additional storage. In one embodiment, at least one of the components indicated heretofore are inter-coupled using various buses, and several of the components may be mounted on a common motherboard.

The mobile compatible processor 752 may execute instructions in the mobile device 750, including instructions stored in the mobile compatible memory 754. The mobile compatible processor 752 may be implemented as a chipset of chips that include separate and multiple analog and digital processors. The mobile compatible processor 752 may provide, for example, for coordination of the other components of the mobile device 750, such as control of user interfaces, applications run by the mobile device 750, and wireless communication by the mobile device 750.

The mobile compatible processor 752 may communicate with a user through the control interface 756 and the display interface 764 coupled to a mobile display 766. In one embodiment, the mobile display 766 may be at least one of a Thin-Film-Transistor Liquid Crystal Display (“TFT LCD”), an Organic Light Emitting Diode (“OLED”) display, and another appropriate display technology. The display interface 764 may comprise appropriate circuitry for driving the mobile display 766 to present graphical and other information to a user. The control interface 756 may receive commands from a user and convert them for submission to the mobile compatible processor 752. In addition, an external interface 762 may be provide in communication with the mobile compatible processor 752, so as to enable near area communication of the mobile device 750 with other devices. External interface 762 may provide, for example, for wired communication in some embodiments, or for wireless communication in other embodiments, and multiple interfaces may also be used.

The mobile compatible memory 754 may be coupled to the mobile device 750. The mobile compatible memory 754 may be implemented as at least one of a volatile memory and a non-volatile memory. The expansion memory 778 may also be coupled to the mobile device 750 through the expansion interface 776, which may comprise, for example, a Single In Line Memory Module (“SIMM”) card interface. The expansion memory 778 may provide extra storage space for the mobile device 750, or may also store an application or other information for the mobile device 750. Specifically, the expansion memory 778 may comprise instructions to carry out the processes described above. The expansion memory 778 may also comprise secure information. For example, the expansion memory 778 may be provided as a security module for the mobile device 750, and may be programmed with instructions that permit secure use of the mobile device 750. In addition, a secure application may be provided on the SIMM card, along with additional information, such as placing identifying information on the SIMM card in a non-hackable manner.

The mobile compatible memory 752 may comprise at least one of a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on at least one of the mobile compatible memory 754, the expansion memory 778, a memory coupled to the mobile compatible processor 752, and a propagated signal that may be received, for example, over the transceiver 758 and/or the external interface 762.

The mobile device 750 may communicate wirelessly through the communication interface 772, which may be comprised of a digital signal processing circuitry. The communication interface 772 may provide for communications using various modes and/or protocols, such as, at least one of: a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol. Such communication may occur, for example, through the radio-frequency transceiver 758. In addition, short-range communication may occur, such as using a Bluetooth®, Wi-Fi, and/or other such transceiver. In addition, a GPS (“Global Positioning System”) receiver module may provide additional navigation-related and location-related wireless data to the mobile device 750, which may be used as appropriate by a software application running on the mobile device 750.

The mobile device 750 may also communicate audibly using an audio codec 760, which may receive spoken information from a user and convert it to usable digital information. The audio codec 760 may likewise generate audible sound for a user, such as through a speaker (e.g., in a handset of the mobile device 750). Such a sound may comprise a sound from a voice telephone call, a recorded sound (e.g., a voice message, a music files, etc.) and may also include a sound generated by an application operating on the mobile device 750.

The mobile device 750 may be implemented in a number of different forms, as shown in the figure. In one embodiment, the mobile device 750 may be implemented as a smartphone 768. In another embodiment, the mobile device 750 may be implemented as a personal digital assistant (“PDA”). In yet another embodiment, the mobile device, 750 may be implemented as a tablet device 770.

Various embodiments of the systems and techniques described here can be realized in at least one of a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal display (“LCD”) monitor) for displaying information to the user and a keyboard and a mouse 724 by which the user can provide input to the computer. Other kinds of devices can be used to provide for interaction with a user as well; for example, feedback provided to the user can be any form of sensory feedback (e.g., visual feedback, auditory feedback, and/or tactile feed-back) and input from the user can be received in any form, including acoustic, speech, and/or tactile input.

The systems and techniques described here may be implemented in a computing system that comprises at least one of a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may comprise at least one of a local area network (“LAN”) and a wide area network (“WAN”) (e.g., the Internet). The computing system can comprise at least one of a client and a server. In one embodiment, the client and the server are remote from each other and interact through the communication network.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A machine-implemented method, comprising:
determining, by a processor of a server device, a baseline travel time of a fleet vehicle traveling a fleet route from a departure location to an arrival location;
obtaining, by the processor of the server device, a dispatch estimated travel time of the fleet vehicle traveling the fleet route from a dispatcher of the fleet vehicle;
obtaining, by the processor of the server device, a driver estimated travel time of the fleet vehicle traveling the fleet route from a driver of the fleet vehicle;
determining, by the processor of the server device, an actual travel time of the fleet vehicle traveling the fleet route through a geospatial tracking device coupled to the fleet vehicle; and
generating, by the processor of the server device, a driver performance score of the driver of the fleet vehicle for a duration of the fleet route based on the baseline travel time, the dispatch estimated travel time, the driver estimated travel time, and the actual travel time.

2. The method of claim 1, wherein the baseline travel time is determined by a baseline travel algorithm applied by the processor of the server device through a baseline travel module.

3. The method of claim 2, wherein the baseline travel algorithm comprises segmenting a total distance of the fleet route into a plurality of sub-distances by a posted speed limit of each of the plurality of sub-distances, dividing the plurality of sub-distances by their respective posted speed limits to obtain a plurality of resultant sub-distance travel times, and summing the plurality of resultant sub-distance travel times to obtain the baseline travel time.

4. The method of claim 1, wherein the baseline estimated travel time and the driver estimated travel time comprises at least one of: a plurality of unplanned stop time periods and a plurality of planned stop time periods.

5. The method of claim 1, further comprising:
generating, by the processor of the server device, an optimum driving route for the remainder of the fleet vehicle's fleet route when the actual travel time for a portion of the fleet route is above at least one of the dispatch estimated travel time and the driver estimated travel time by a variance threshold time; and
transmitting, by the processor of the server device, the optimum driving route to a display of the fleet vehicle communicatively coupled to the server device.

6. The method of claim 1, wherein the driver performance score is determined by a driver performance algorithm applied by the processor of the server device through a driver performance module.

7. The method of claim 1, wherein the driver performance algorithm comprises:
determining a dispatch variance value by obtaining a percentage variance between the dispatch estimated travel time and the baseline travel time,
determining a driver estimated variance value by obtaining a percentage variance between the driver estimated travel time and the baseline travel time,
determining an actual variance value by obtaining a percentage variance between the actual travel time and the baseline travel time, and
aggregating the dispatch variance value, the driver estimated variance value, and the actual variance value to obtain the driver performance score of the driver of the fleet vehicle for the fleet route traveled.

8. The method of claim 1, wherein the driver performance score of the driver is compared against the performance scores of other drivers of other fleet vehicles and a comparison score is determined by the processor of the server device.

9. A fleet vehicle driver assessment system, comprising
a geospatial tracking device coupled to a fleet vehicle communicatively coupled to one or more server devices; and
the one or more server devices configured to:
calculate, by one or more processors of the one or more server devices, a baseline travel time of the fleet vehicle traveling a fleet route from a departure location to an arrival location,
obtain, by the one or more processors of the one or more server devices, a dispatch estimated travel time of the fleet vehicle traveling the fleet route from a dispatcher of the fleet vehicle,
obtain, by the one or more processors of the one or more server devices, a driver estimated travel time of the fleet vehicle traveling the fleet route through a driver mobile device communicatively coupled to the one or more server devices,
determine, by the one or more processors of the one or more server devices, an actual travel time of the fleet vehicle traveling the fleet route through the geospatial tracking device coupled to the fleet vehicle, and
generate, by the one or more processors of the one or more server devices, a driver performance score of the driver of the fleet vehicle for a duration of the fleet route based on the baseline travel time, the dispatch estimated travel time, the driver estimated travel time, and the actual travel time.

10. The system of claim 9, wherein the baseline travel time is determined by a baseline travel algorithm applied by the one or more processors of the one or more server devices through a baseline travel module.

11. The system of claim 10, wherein the baseline travel algorithm comprises segmenting a total distance of the fleet route into a plurality of sub-distances by a posted speed limit of each of the plurality of sub-distances, dividing the plurality of sub-distances by their respective posted speed limits to obtain a plurality of resultant sub-distance travel times, and summing the plurality of resultant sub-distance travel times to obtain the baseline travel time.

12. The system of claim 9, wherein the baseline estimated travel time and the driver estimated travel time comprises at least one of: a plurality of unplanned stop time periods and a plurality of planned stop time periods.

13. The system of claim 9, further comprising:
generating, by the one or more processors of the one or more server devices, an optimum driving route for the remainder of the fleet vehicle's fleet route when the actual travel time for a portion of the fleet route is above at least one of the dispatch estimated travel time and the driver estimated travel time by a variance threshold time; and
transmitting, by the one or more processors of the one or more server devices, the optimum driving route to a display of the driver mobile device communicatively coupled to the server device.

14. The system of claim 9, wherein the driver performance score is determined by a driver performance algorithm applied by the one or more processors of the one or more server devices through a driver performance module.

15. The system of claim 1, wherein the driver performance algorithm comprises:
determining a dispatch variance value by obtaining a percentage variance between the dispatch estimated travel time and the baseline travel time,
determining a driver estimated variance value by obtaining a percentage variance between the driver estimated travel time and the baseline travel time,
determining an actual variance value by obtaining a percentage variance between the actual travel time and the baseline travel time, and
aggregating the dispatch variance value, the driver estimated variance value, and the actual variance value to obtain the driver performance score of the driver of the fleet vehicle for the fleet route traveled.

16. A server device, comprising:
a baseline travel module configured to determine a baseline travel time of a fleet vehicle traveling a fleet route from a departure location to an arrival location;
a dispatcher module configured to obtain a dispatch estimated travel time of the fleet vehicle traveling the fleet route from a dispatcher of the fleet vehicle;
a driver tracking module configured to obtain a driver estimated travel time of the fleet vehicle traveling the fleet route from a driver of the fleet vehicle;
a vehicle tracking module configured to determine an actual travel time of the fleet vehicle traveling the fleet route through a geospatial tracking device coupled to the fleet vehicle and in communicative contact with the server device; and
a driver performance module configured to generate a driver performance score of the driver of the fleet vehicle for a duration of the fleet route based on the baseline travel time, the dispatch estimated travel time, the driver estimated travel time, and the actual travel time.

17. The server device of claim 16, wherein the baseline travel time is determined by a baseline travel algorithm and the driver performance score is determined by a driver performance module.

18. The server device of claim 17, wherein the baseline travel algorithm comprises segmenting a total distance of the fleet route into a plurality of sub-distances by a posted speed limit of each of the plurality of sub-distances, dividing the plurality of sub-distances by their respective posted speed limits to obtain a plurality of resultant sub-distance travel times, and summing the plurality of resultant sub-distance travel times to obtain the baseline travel time.

19. The server device of claim 17, wherein the driver performance algorithm comprises:
determining a dispatch variance value by obtaining a percentage variance between the dispatch estimated travel time and the baseline travel time,
determining a driver estimated variance value by obtaining a percentage variance between the driver estimated travel time and the baseline travel time,
determining an actual variance value by obtaining a percentage variance between the actual travel time and the baseline travel time, and
aggregating the dispatch variance value, the driver estimated variance value, and the actual variance value to obtain the driver performance score of the driver of the fleet vehicle for the fleet route traveled.

20. The server device of claim 16, further comprising:
a mapping module configured to:
generate an optimum driving route for the remainder of the fleet vehicle's fleet route when the actual travel time for a portion of the fleet route is above at least one of the dispatch estimated travel time and the driver estimated travel time by a variance threshold time; and
transmit the optimum driving route to a display of the fleet vehicle communicatively coupled to the server device.
